(19) United States
(12) Patent Application Publication
(10) Pub. No.: US 2006/0224797 A1
(43) Pub. Date: Oct. 5, 2006

(54) Command and Control Architecture

(76) Inventors: Warren G. Parish, Sarasota, FL (US); Michael T. McKibben, Columbus, OH (US)

Correspondence Address: ERIC D. JORGENSON, 1457 KING ROAD, HINCKLEY, OH, 44233, US

(21) Appl. No.: 11/278,495

(22) Filed: Apr. 3, 2006

Related U.S. Application Data
(60) Provisional application No. 60/667,778, filed on Apr. 1, 2005.

(51) Int. Cl. G06F 13/38

(52) U.S. Cl. 710/62

(57) ABSTRACT

A command and control architecture that facilitates detection of a situation and, processing, notifying and communicating alerts, and calling for services. However a situation is ascertained, whether a sensor senses it, a human observes it, and/or the physical location of police cars, emergency vehicles, fire vehicles are ascertained, attributes of each of the sensors, observer, and/or assets can get passed both to a mapping component that maintains situation awareness information for presentation on a map. The attribute data is also analyzed with the results data passed to the central communications component for data and communications management, further facilitating notification and alerting of the appropriate services to get the appropriate people and equipment involved, and then linking it other data sources to further support the system functions.

### CROSS-REFERENCE TO RELATED APPLICATIONS

This application claims the benefit of U.S. Provisional Patent application Ser. No. 60/667,778 entitled “COMMAND AND CONTROL ARCHITECTURE” and filed Apr. 1, 2005, the entirety of which is incorporated by reference herein.

### TECHNICAL FIELD

This invention is related to command and control systems, and more specifically, to such systems that employ detection, analysis, data processing, and communications for emergency services.

### BACKGROUND

The advent of global communications networks such as the Internet has facilitated numerous collaborative enterprises. Telephone and IP networks (e.g., the Internet) facilitate bringing individuals together in communication sessions to conduct business via voice and video conferencing, for example. However, the challenge of communications interoperability continues to plague public safety and emergency services agencies. Such interoperability could give first responders, elected officials, and public safety agencies the capability to exchange voice and data on-demand and in real time, when needed and as authorized.

National security incidents (e.g., terrorist attacks, bombings, . . . ) and natural disasters (e.g., hurricanes, earthquakes, floods, . . . ) have exposed that true interoperability requires first responders and elected officials to be able to communicate not just within their units, but also across disciplines and jurisdictions. Additionally, full communications interoperability is required at all levels, for example, at the local, state, and federal levels. Conventional network availability has proven to be difficult to maintain in unpredictable environments such as firestorms, natural disasters, and terrorist situations. Too often communications depend on access to fixed or temporary infrastructure and are limited by range or line-of-sight constraints. Moreover, radio interoperability between jurisdictions (e.g., local, state, federal) is always an issue for responders and has become a homeland security matter. Furthermore, proprietary radios and multiple standards and their lack of interoperability with wired and wireless telephony (also called telecommunications) networks make it virtually impossible for different agencies to cooperate in a scaled response to a major disaster.

Accordingly, reliable wireless and/or wired communications that enable realtime information sharing, constant availability, and interagency interoperability are imperative in emergency situations. Additionally, greater situational awareness is an increasingly important requirement that enables emergency first responders to know each other's position in relation to the incident, terrain, neighborhood, or perimeter being secured. Live video, voice communication, sensor, and location data provide mission-critical information, but low-speed data networks cannot adequately meet the bandwidth requirements to support such critical realtime information. When catastrophic events occur, a comprehensive coordinated effort based on timely, effective communications between any or all of fire, police, emergency services and/or elected officials is necessary to cope with the situation. Therefore, what is needed is an improved interoperable command and control communications architecture.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The invention disclosed and claimed herein, in one aspect thereof, comprises a command and control architecture that facilitates detection of a situation or event that is taking place. The architecture employs sensors and sensors systems, as well as existing systems, for processing, notifying and communicating alerts, and calling for the appropriate public safety and emergency services. Thus, whatever situation or event, whether a sensor senses it, a human observes it, and/or the physical location of police cars, emergency vehicles, fire vehicles are ascertained, attributes of each of the sensors, observer, and/or assets can be passed to central communications system (e.g., web-based) for further processing and analysis. For example, a mapping component can be employed that generates one or more maps for routing services to and from the situation location. The attribute data is also analyzed, with the results data passed to the central communications system for data and communications management, further facilitating notification and alerting of the appropriate services to get the right people and equipment involved, and then linking it to other data sources in further support the system functions.

In support thereof, there is provided a command and control system, comprising a detection component that facilitates sensing of a situation and data analysis of detection data, a central communications component (e.g., Internet-based) that provides data and communications management related to the detection data, and a mapping component that processes the detection data and presents realtime location information related to a location of the situation. The detection component includes at least one of a sensor that senses situation parameters, an observer that observes the situation, and/or an asset that is located near the situation.

The mapping component includes a geographic location technology that facilitates locating at least one of the sensor, the observer, and the asset. The sensor is associated with situation attributes that are analyzed, the observer is associated with human attributes that are analyzed, and the asset is associated with asset attributes that are analyzed. The asset attributes are representative of a location of at least one of a fire vehicle, a medical vehicle, and a law enforcement vehicle. The sensor attributes are representative of a at least one of chemical data, explosives data, drug data, motion data, biological data, weapons data, acoustical data, nuclear data, audio data, and video data.

The human attributes are representative of at least one of voice data, visual data, tactile data, motion data, and audio data. The system further comprises a tactical component that processes tactical data for at least one of the mapping component, the central communications component, and the detection component. The system further comprises a security system that initiates a security action based on the detection data. The security action includes requesting at least one of a fire services, medical services, and law enforcement services. The central communications component facilitates communications over at least one of a cellular network and an IP network. The central communications component facilitates at least one of information rights management, voice/video and data collaboration, file management, workflow management, searching and indexing, and voice/text alerting. The voice/text alerting includes an alert related to detection by the diction component of at least one of nuclear data, chemical data, biological data, and radiological data.

The system further comprises an external interface component that facilitates communications to a law enforcement database. A computer-readable medium is provided having stored thereon computer-executable instructions for carrying out the system. The detection component facilitates at least one of explosives analysis and drug analysis.

In yet another aspect thereof, a machine learning and reasoning component is provided that employs a probabilistic and/or statistical-based analysis to prognose or infer an action that a user desires to be automatically performed.

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a command and control system in accordance with the invention.

FIG. 2 illustrates a methodology of providing a command and control communications capability in accordance with an innovative aspect.

FIG. 3 illustrates a flow diagram of a methodology of notifying law enforcement based on situation analysis.

FIG. 4 illustrates a methodology of communicating command and control information via a web-based communication architecture, according to a novel aspect.

FIG. 5 illustrates a more detailed block diagram of a detection and analysis component of a command and control system.

FIG. 6 illustrates a more detailed block diagram of a central communications component of a command and control system in accordance with an innovative aspect.

FIG. 7 illustrates a more detailed block diagram of a mapping component for a command and control system.

FIG. 8 illustrates a more detailed block diagram of a tactical component, a security systems component, and external systems interface component of a command and control system.

FIG. 9 illustrates a detailed overall diagram of a system that facilitates aspects of the disclosed novel architecture.

FIG. 10 illustrates a diagram of a command and control system that employs artificial intelligence in the form of machine learning and reasoning component which facilitates automating one or more features in accordance with the subject innovation.

FIG. 11 illustrates a flow diagram of a methodology of developing a model based on event and system information in accordance with an aspect.

FIG. 12 illustrates a flow diagram of a methodology of processing situation movement and characteristics for command and control processing according to an aspect.

FIG. 13 illustrates a block diagram of a computer operable to facilitate execution of one or more components of the disclosed command and control architecture.

FIG. 14 illustrates a diagram of a network environment that facilitates command and control in accordance with the invention.

### DETAILED DESCRIPTION OF THE INVENTION

The invention is now described with reference to the drawings, wherein like reference numerals are used to refer to like elements throughout. In the following description, for purposes of explanation, numerous specific details are set forth in order to provide a thorough understanding of the subject invention. It may be evident, however, that the invention can be practiced without these specific details. In other instances, well-known structures and devices are shown in block diagram form in order to facilitate describing the invention.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

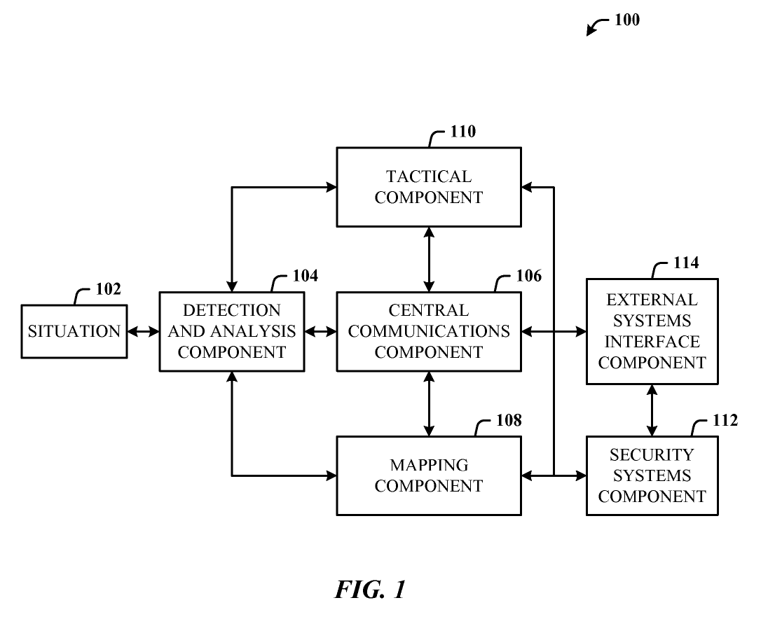

Referring initially to the drawings, FIG. 1 illustrates a command and control system 100 in accordance with the invention. The system 100 facilitates the processing of a situation 102 and, provides a data and communications infrastructure that automatically analyzes situation aspects, provides alerts and notifications, and facilitates dispatch of public safety and/or emergency services (e.g., fire, medical, police, . . . ) to the situation location and/or along routes to the situation area.

A detection and analysis component 104 facilitates the sensing and analysis of situation data. The situation data can include properties and characteristics of the situation, such as the type of situation (e.g., human, animal, machine, chemical, biological, nuclear, . . . ), environmental conditions at the situation area, as well as the situation location and general size information.

The output of the detection and analysis component 104 can be communicated to a central communications component 106 that provides data and communications services for the system 100. In one implementation, this is a web-based (also referred to as Internet-based) communications system that facilitates multi-user, multi-connectivity to a common session, for example, such that users at several common or different levels can communicate with one another. Such a capability can be provided via a web-based teleconferencing and communications system by Leader Technologies, Inc., which allows at least for secure communications at multiple levels for of security and emergency response, for example, including for push-to-talk systems.

A mapping component 108 provides location and situational awareness services that facilitate locating, according to a geographic location technology (e.g., Global Positioning System-GPS) at least any of the sensing mechanisms of the detection and analysis component 104. Broadly speaking, situational awareness is a state of knowledge of the situation or event. An individual's and/or system's understanding and classification of the situation or event forms the basis for all subsequent decisionmaking and performance. More specifically, situational awareness is the capability of being aware of all or a substantial amount of everything that is happening for a given situation, as well as the relative importance of everything that is being observed. This includes the state of the environment of a constantly evolving situation or event.

Situational awareness is important for effective decisionmaking and performance in any complex and dynamic environment not only at the current time but in the near future. Levels of situational awareness involve perceiving critical factors in the environment, understanding what those factors mean, particularly when integrated together in relation to the decision maker's goals, and understanding of what will happen with the system in the near future. These levels of awareness allow people and associated systems to function in a timely and effective manner.

In support thereof, the mapping component 108 can further include capabilities related to radio communications, messaging systems and, orders and commands systems. Additionally, the mapping component 108 can present the location data (e.g., as represented by streets, addresses, buildings, physical structures, terrestrial structures, cities, counties, countries, and so on) in the form of video or graphical representation information as maps via one or more video displays accompanied by multimedia information (e.g., voice, audio, text, . . . ).

The mapping component 108 can also access Internet-based websites that provide weather information and other environmental information, for example, at the situation area, and/or along routes that may be traveled to get to the situation area. This can further include traffic reports and road construction information that can be important to avoid delays or prohibit travel through those areas of normally chosen main routes to the situation area. In view of such information, the dispatched services can be provided with maps that reflect up-to-the-minute road and/or weather conditions when being dispatched to the situation area. Moreover, as the services are in-route, the map or maps provided can be updated to present realtime conditions for travel along the selected routes. For example, camera data from cameras, now becoming more commonly deployed along streets and avenues and on top of buildings, can be accessed via websites or directly from city camera support systems to provide more information for processing related not only to mapping, but to all aspects of the disclosed invention.

The system 100 can also employ a tactical component 110 that can process and provide tactical information (e.g., as related to the situation), and what is a better or best route for dispatched or about to be dispatched services to get the situation area, or any other area related to the situation. This can occur as the event or situation is developing, and/or as a background operation such that the tactical component 110 develops models that consider many different aspects during times when events or situations are not occurring. This capability can be provided by utilizing artificial intelligence as a means for processing historical information, and using that to predict future aspects associated with the subject invention. This will be described in greater detail hereinbelow. Additionally, the tactical component 110 can analyze and determine a better or the best route for traffic (whether services or public) away from the situation area. A security system component 112 provides communications with many types of security and emergency related services systems (e.g., fire, police, military, and medical).

An external systems interface component 114 facilitates interaction by the system 100 and its components (102, 106, 108, 110, and 112) with external data systems (e.g., databases, websites, computing system, portable devices, . . . ), communications systems and networks (e.g., IP networks and cellular networks-wired and/or wireless), and third party hardware and/or software security and/or emergency systems, for example.

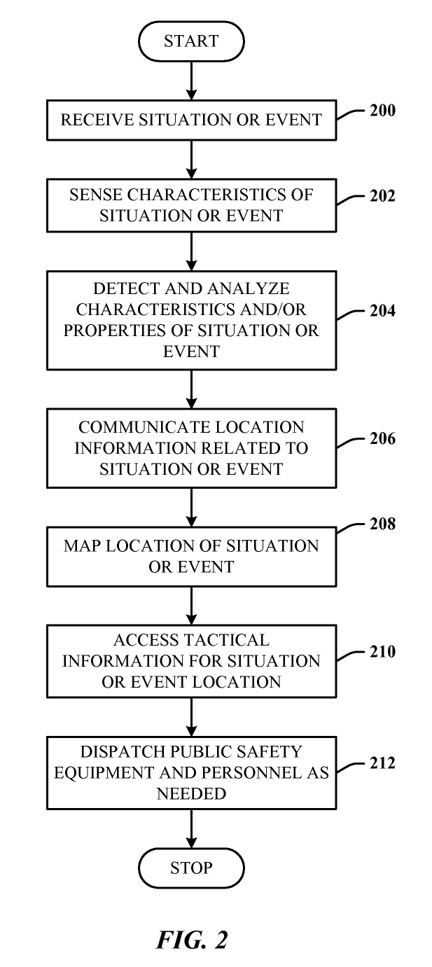

FIG. 2 illustrates a methodology of providing a command and control communications capability in accordance with an innovative aspect. While, for purposes of simplicity of explanation, the one or more methodologies shown herein, for example, in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 200, the situation is detected. At 202, characteristics of the situation are sensed. As indicated, the characteristics can include many different aspects, properties or attributes. For example, dimensions of the situation or event area, whether humans and/or non-human objects are involved, chemical characteristics of objects and/or the situation area, if the situation is migrating in a certain direction, how object or items in the situation area are interacting or moving, multiple situations or a single situation, and so on. At 204, the sensed information is analyzed. In one implementation, detection and analysis can be for materials of interest, such as drugs and/or explosives. In another implementation, it can be a vehicle, or building location, etc. At 206, at least location information related to the situation is communicated to one or more entities. Other information which can be communicated includes situation characteristics information, for example. At 208, at least one map is generated from selected services locations to the situation location. As indicated supra, other maps can be generated also for routes away from the situation. At 210, tactical information is accessed for addressing the situation, the situation threat, and the situation location. At 212, public safety equipment and personnel are automatically dispatched to the situation location based on the maps, tactical information, situation information, and other information developed and communicated.

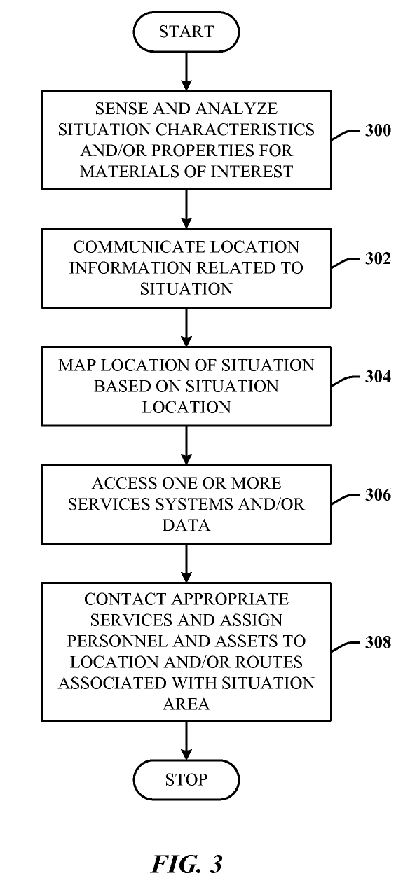

FIG. 3 illustrates a flow diagram of a methodology of notifying law enforcement based on situation analysis. At 300, a situation is detected and sensed for materials and/or objects of interest (e.g., gases, humans, . . . ), and the sensed information (e.g., characteristics) associated therewith analyzed. At 302, situation location information is computed and communicated to other system entities for processing. This can also include any other sensed situation information, such as chemicals, situation dimensions, the situation type, and so on. In particular, sensors and/or sensing systems can include thermal imaging systems, infrared imaging systems, and systems that are capable of detecting chemicals associated with the situation. At 304, the location of the situation can be determined (e.g., by GPS), the coordinates of which can be transmitted in the system for location mapping. In other words, the location of the situation can be presented to users on a map that includes streets, buildings, and/or other structures that will expedite the dispatch and arrival of security and/or emergency services to the situation location. At 306, separately or in combination with the mapping operation, the appropriate services systems (e.g., databases, communications systems, . . . ) can be accessed, and the services notified and dispatched based on the needs determined at the situation location, as indicated at 308.

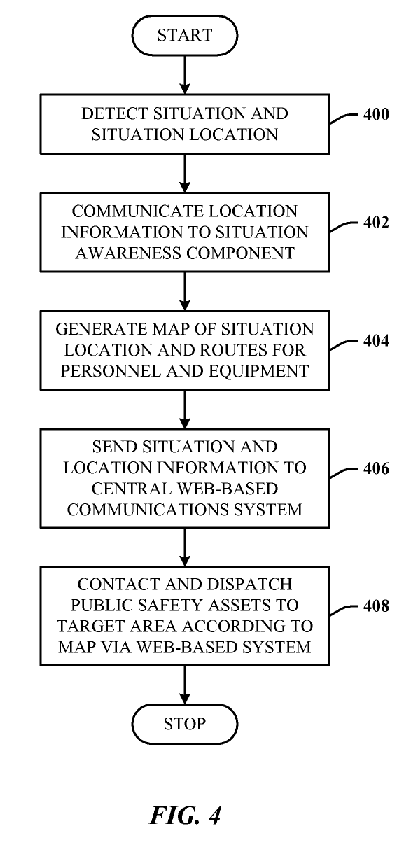

FIG. 4 illustrates a methodology of communicating command and control information via a web-based communication architecture, according to a novel aspect. At 400, the situation is detected and the situation location determined. At 402, the situation information (e.g., the fact that the situation exists, situation location, moving or not, environmental conditions at situation, type of situation, . . . ) is communicated to a situation awareness component for processing. At 404, a map is generated of the situation area. At 406, the situation awareness information, as well as other situation-related information is transmitted to a web-based communications system. At 408, the system processes the information for wide-area communications of portions or all of the information for notification of all public safety and emergency agencies or organizations that normally need to know of such events or situations at the situation area. This can further include facilitating the dispatch of the appropriate personnel and assets to the location using the generated map(s).

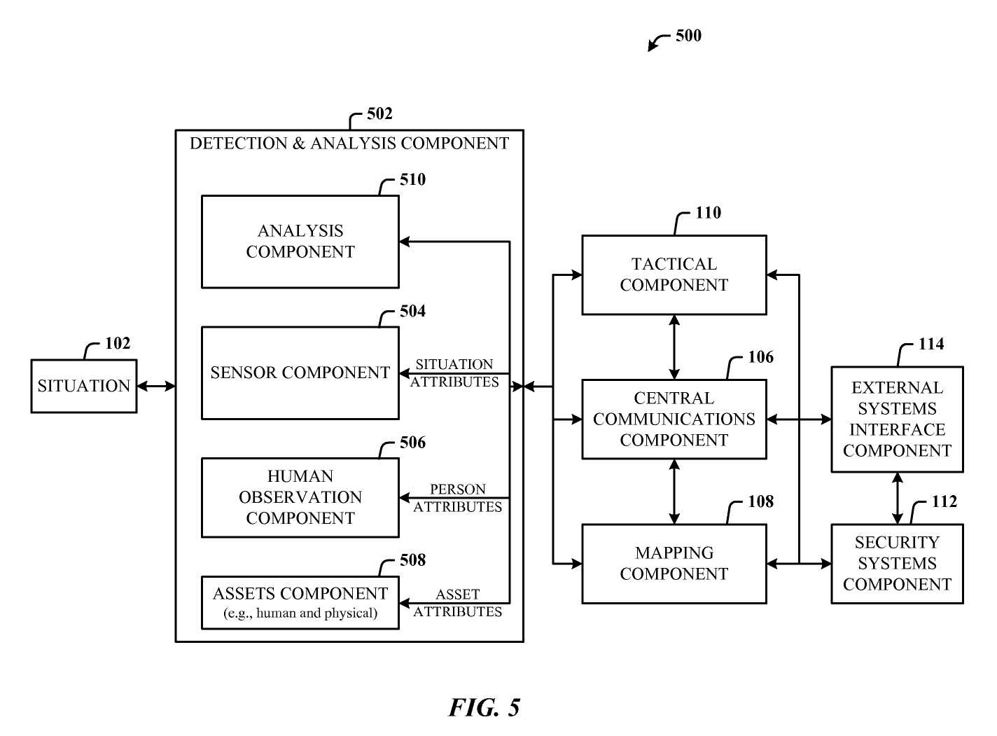

FIG. 5 illustrates a more detailed block diagram of a detection and analysis component 502 (similar to component 104 of FIG. 1) of a command and control system 500. A sensor component 504 facilitates sensing a wide variety of data associated with the situation 102. For example, chemicals, drugs, explosives, motion, direction, sounds, biological data, environmental data (e.g., altitude, humidity, temperature, pressure, . . . ), situation object and area dimensions, size, can be determined and analyzed alone or in combination with other information. These are indicated as part of the situation attributes, as communicated between the sensor component 504 and other components of the system 500.

A human observation component 506 facilitates input of data observed by a human (person attributes) such as from a police officer who is at the situation location and who can transmit information observed directly, or perhaps received from a person to which the officer is speaking. Indirectly speaking, the observed information can also include that which is perceived (e.g., viewed, heard, . . . ) through equipment (e.g., a camera, speaker, . . . ).

An assets component 508 provides data input related to human and/or physical entities (e.g., vehicles and equipment). For example, the presence of firefighters and fire equipment can be inferred to indicate that an event or situation that includes fire and/or smoke is occurring in an area, or could be, based on other sensed data (e.g., fumes from gasoline or other volatile substances). In another example, a fire alarm can indicate that a fire is occurring and that fire-related assets should be dispatched to the situation location. It is to be understood that asset signals (e.g., personnel and equipment called to the area) can be monitored before arriving at the situation area, while in operation at the situation area, and after leaving the situation area. Asset attributes can be communicated between the assets component 508 and other components of the system 500.

An analysis component 510 can receive information from at least any of the previously mention components (504, 506, and 508) and process some or all of it to facilitate determining aspects of the situation 102. For example, sensors and/or sensing systems can be provided that detect that the situation includes a fire, or an associated chemical component represents a property of a drug or an explosive. Additionally, the input from a human observer, as communicated via an emergency 9-1-1 call can further provide information that there is a fire at a location, the location information being processed and ultimately providing corroboration that the situation area includes a fire. Still further, a police officer at the location of the situation 102 calls in to report that a person at the location is near a fire, and suspected in starting the fire.

Thus, all this information or portions thereof can be communicated to the analysis component 510 for processing, as well as to other entities, such as the central communications component 106 for dispersement to other personnel and systems, the tactical component 110 for tactical analysis and processing, the mapping component 108 for map generation and other situation awareness processing, the security component 112 for communicating with emergency and security services, and the external systems component 114 for interaction communications with other systems.

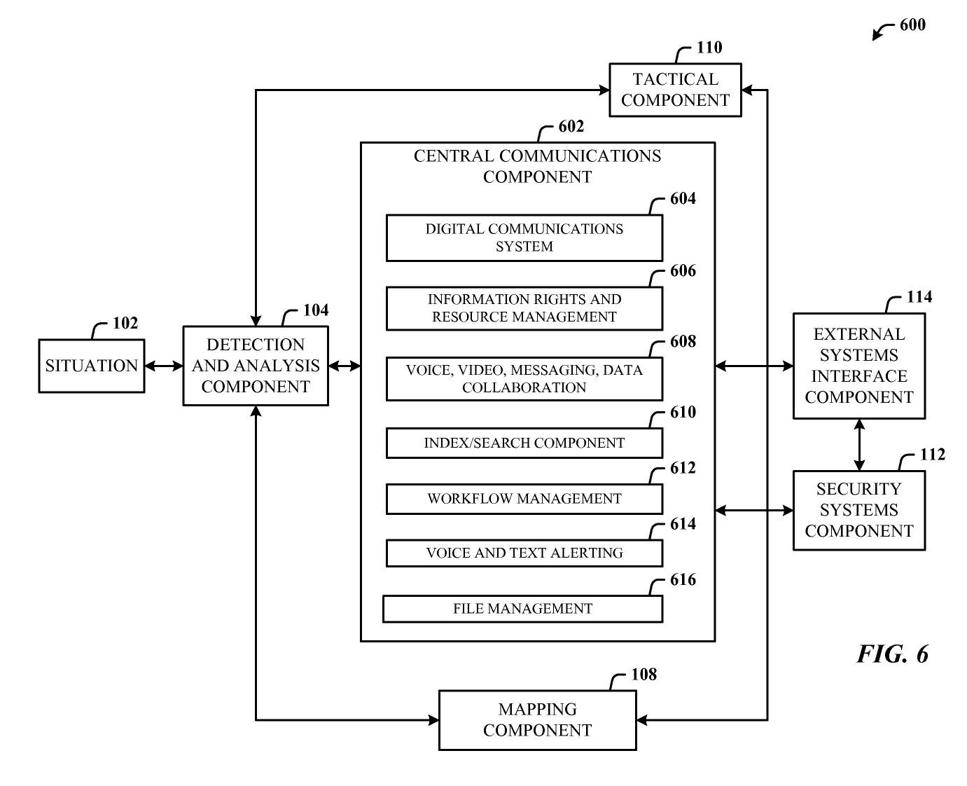

FIG. 6 illustrates a more detailed block diagram of a central communications component 602 (similar to component 106 of FIG. 1) of a command and control system 600 in accordance with an innovative aspect. The component 602 can include a digital communications system 604 (e.g., web-based) that facilitates at least IP communications. A network on which the component 602 is disposed can be the Internet. Accordingly, proper security access network measures (e.g., AAA-authentication, authorization, and accounting) can be employed to ensure that only authorized and secured access by users is provided. Accordingly, an information rights and resource management component 606 can be provided to assist data access control. Additionally, information management analyzes information as an organizational resource, covering definitions, values, uses, and distribution of data and information whether processed by computer or not. Voice, video, messaging and data collaboration can also be provided by a component 608.

An indexing and/or search component 610 facilitates query processing for searches (whether machine generated and/or user generated) for data and other information stored in the system 600. A workflow management component 612 for at least the automatic routing of documents to users and other system entities. The documents or data can be transmitted over the network or maintained in a single database with the appropriate users given access to the data at the required times. Moreover, triggers can be implemented in the system to alert users when information is overdue. This can be facilitated by a voice and text alerting component 614 (e.g., e-mail, SMS-short message service, MMS-multimedia message service). File management and storage is facilitated by a file management component 616. Virtually all information associated with sensing, communications, situation, users, etc., can be logged and recorded for analysis and processing.

Thus, all this information or portions thereof can be communicated to the central communications component 602 for storage, processing, further analysis, and routing, as well as to other entities, such as the detection and analysis component 104 for data and analysis communications, management and control of sensors and sensing systems, human observation component and assets component, the tactical component 110 for tactical analysis and processing, the mapping component 108 for map generation and other situation awareness processing, the security component 112 for communicating with emergency and security services, and the external systems component 114 for interaction communications with other systems.

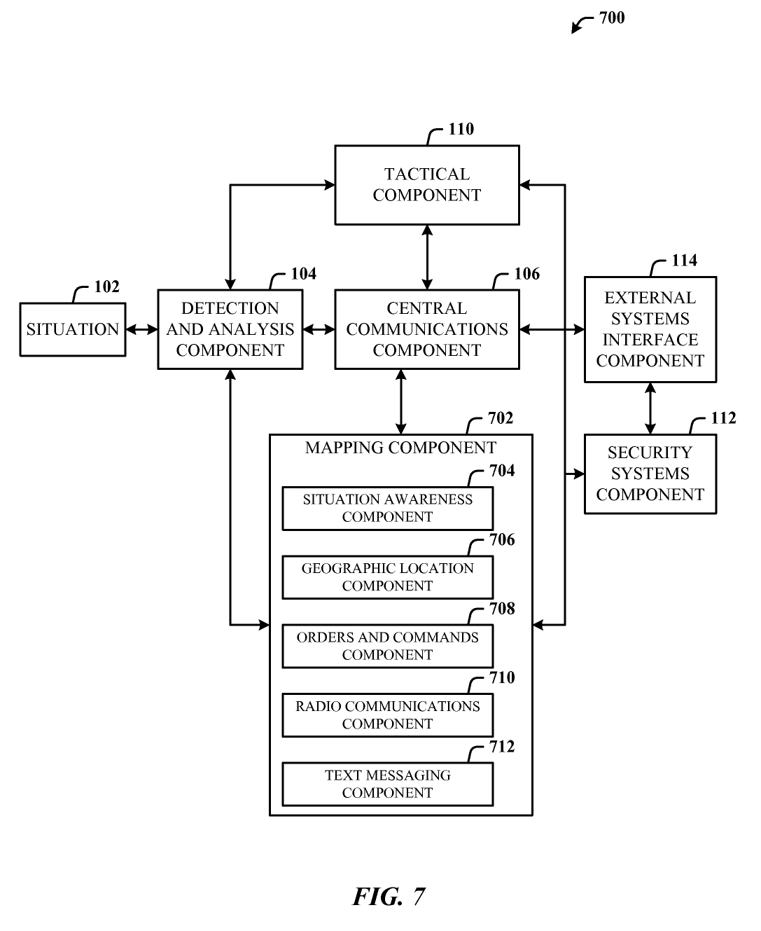

FIG. 7 illustrates a more detailed block diagram of a mapping component 702 (similar to component 108 of FIG. 1) for a command and control system 700. The mapping component 702 can include a situational awareness component 704, a geographical location 706, and orders and commands component 708, a radio communications component 710 and a text messaging component 712. The geographical component 706 facilitates determination of coordinate information (e.g., latitude and longitude) and/or triangulation data, for example. Other suitable technologies can also be employed insofar as location of the situation and other entities can be determined. In the cellular industry, location information can be obtained by E911 technology which, if the situation includes a user that has an operational cellular telephone, can facilitate determining the location of the user.

The orders and commands component 708 facilitates processing and issuing of orders and/or commands associated with processing all aspects of the situation and/or situation area. For example, after a map has been generated, it can be displayed on display devices to field personnel, as well as personnel in-charge on location and/or at remote locations that may be viewing the situation remotely. Not only can orders and/or commands be issued by any of these personnel, but these orders and/or commands can be converted into text (via the text messaging component 712) and be displayed on the map, as well, or on a separate display system or handheld text-capable devices. This capability facilitates perception of the orders and/or commands when audio capability may be impaired by systems and/or personnel, for example.

The radio communications component 710 facilitates related communications to personnel in the field from any number of different entities deemed to be in charge of the situation, and/or from remote systems that facilitate oversight of the situation or event. For example, push-to-talk systems can be monitored, and in some scenarios, interrupted by personnel remotely located to further provide command and control. The situational awareness component 704 can receive any or all of the information provided by the components (706, 708, 710 and 712), as well as information from external components of the system 700, in order to provide an overall situation report as to the current state of personnel and/or assets assigned to the event or situation.

Thus, all this information or portions thereof can be communicated to the central communications component 106 for storage, processing, and routing, as well as to other entities such as the detection and analysis component 104 for data and analysis communications, management and control of sensors and sensing systems, human observation component and assets component, the tactical component 110 for tactical analysis and processing, the security component 112 for communicating with emergency and security services, and the external systems component 114 for interaction communications with other systems.

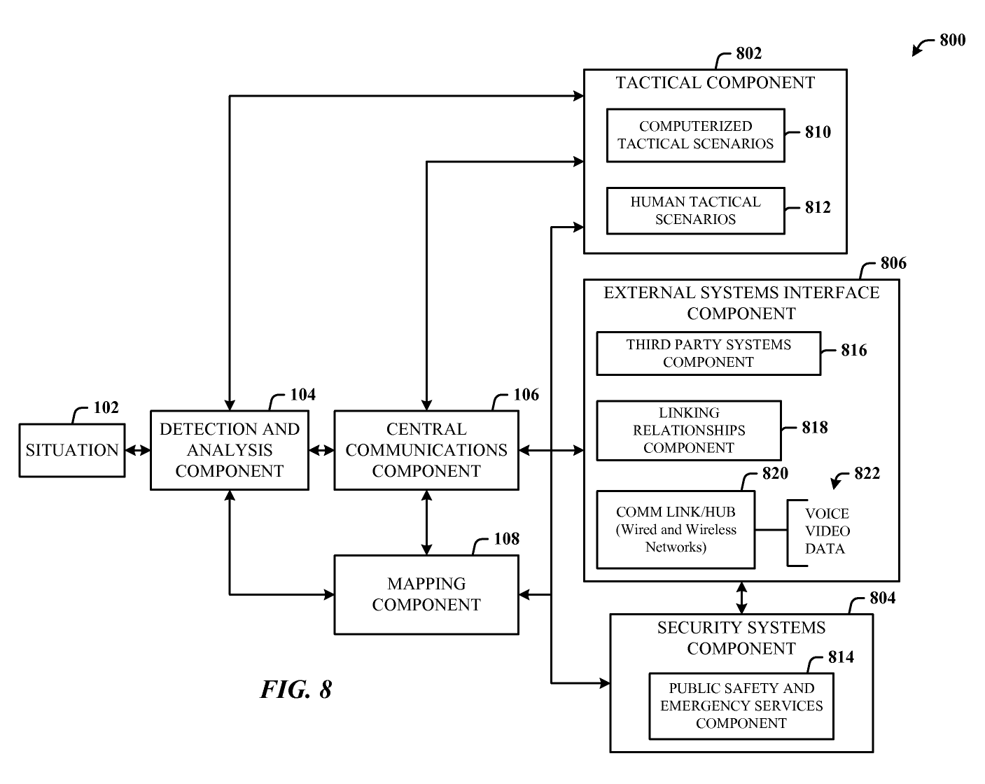

FIG. 8 illustrates a more detailed block diagram of a tactical component 802, a security systems component 804, and external systems interface component 806 (all similar to respective components 110, 112, and 114 of FIG. 1) of a command and control system 800.

The tactical component 110 facilitates tactical information processing. A computerized tactical scenarios component 810 of component 110 provides for simulated processing of scenarios during off-peak times in preparation for events that may occur in the future at locations identified as high risk, for example. With respect to terrorist activities, for example, large population centers or areas where people congregate (e.g., subways, stadiums, buildings, . . . ) can be processed that consider the location of security and emergency services locations in a given area, and their availability during various times.

Risk analysis, for example, can be performed based on past or historical data accumulated and stored for each of these areas, and models developed such that should an event occur in that area or location, and should the data sensed indicate that a certain model is suitable for execution, the model will be selected for execution. The model can include information for contacting the appropriate services, agencies, and personnel based on the event and the location, and as may be developed in the evolving situation report. Models can be updated and tested over time so as to provide readily available model execution for scenarios that may develop. Other types of analysis can be performed, as well, for model development. For example, models can be developed and utilized based on time to location for many different services. This can further be based on traffic patterns, and seasonal considerations related to weather, road conditions, tourist conditions, and other increases of population (e.g., migrations to warmer parts of the country during colder times of the year), and so on. Models can be continually updated based on newer technologies being implemented for communications, demographic changes, and so on.

A human tactical scenarios component 812 can be utilized for modeling human actions to known events and/or simulated events. For example, hospitals, medical personnel, police, fire fighters, weapons teams, biohazard teams, chemical spill teams, and so on, all have associated reaction times to events or situations. These times can be logged along with routes taken, and models generated based at least on this information. In a specific implementation example, databases can be accessed that indicate who is on duty for a given day. It can be tracked and determined that a certain crew can react faster to an event than another crew. Accordingly, this information can be included in the models.

The security system component 804 facilitates access to one or more security systems (e.g., fire, break-in systems, intercom systems, . . . ) in building and structures of the area (e.g., regional, city, county, . . . ) that can be connected and monitored. A public safety and emergency services component 814 can also facilitate connecting and monitoring of public safety systems, such as the EBS (emergency broadcast system), severe weather alert systems, radio and television emergency systems, and so on.

The external systems interface component 806 facilitates communications with third party systems (e.g., databases) such as police or law enforcement agencies (e.g., via COPLink™) through a third party systems component 816. A linking relationships component 818 provides suitable communications interfaces to other types of external systems using conventional communications protocols (e.g., cellular, IP network, land line, shortwave radio, push-to-talk radio, . . . ). A communications link and hub component 820 (denoted COMM LINK/HUB) facilitates wired and/or wireless communications links (e.g., IP networks, satellite systems, cellular networks, . . . ) for video, voice, images, audio, data, and other desired forms of data.

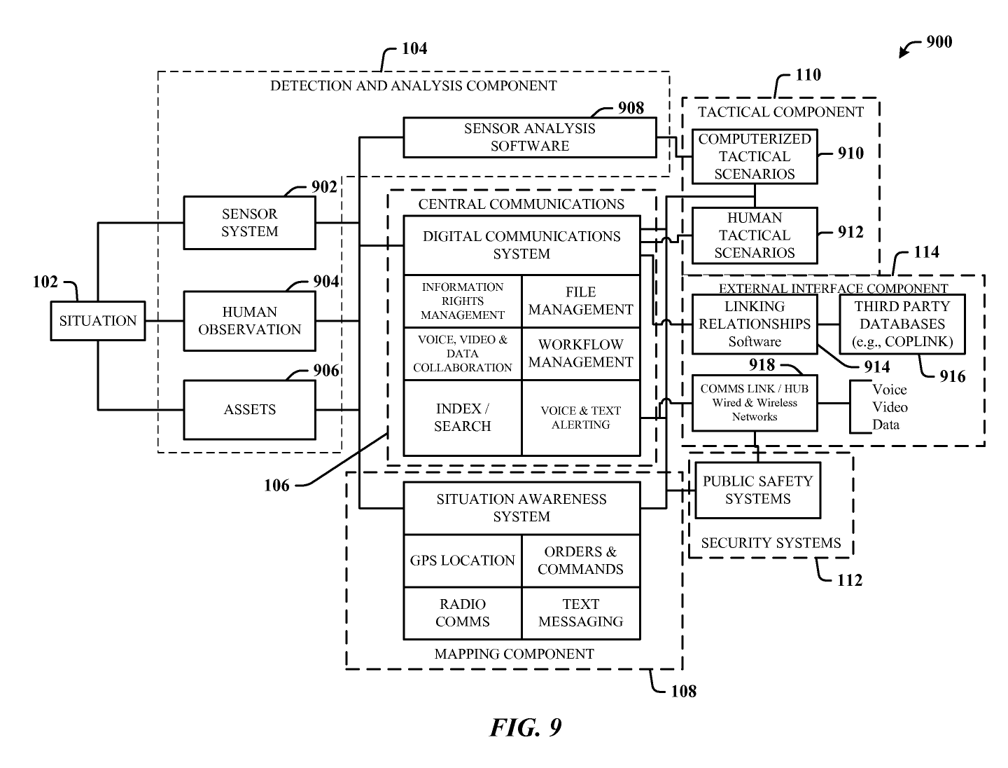

Referring now to FIG. 9, there is illustrated a detailed overall diagram of a system 900 that facilitates all aspects of the disclosed novel architecture. The detection and analysis component 104 can include a sensor block 902 that senses and outputs situation attributes associated with the outputs of many types of sensors and sensing devices/systems that can be employed to sense various aspects of the situation 102. For example, such sensors and systems can include those related to detecting properties related to chemicals, explosives, drugs, and weapons (e.g., WMDs—weapons of mass destruction), motion, audio sources, biological sources, radiological sources, acoustical sources, audio data, temperature, humidity, and pressure, to name just a few.

The detection and analysis component 104 also includes a human observation component 904 that outputs human (or observer) attributes such as for a human observer that uses associated human senses and capabilities, for example, to perceive, engage, and/or track the situation 102. An assets component 906 outputs asset attributes related to, for example, both human and physical assets. The detection and analysis component 104 also includes sensor analysis software component 908 that facilitates the detection and analysis of situation characteristics or chemical properties related to explosives and/or drugs, for example.

The central communications component 104 provides centralized data and communications management of the system 900. The component 104 includes support and mechanisms for user data and, file exchange and collaboration (e.g., Leaderboard™ software by Leader Technologies, Inc.), information rights and resource management, file management, workflow management, voice, video and data collaboration, data indexing and searching and, voice and text alerting. The alerts can be related to many types of detected attributes, including, but not limited to, biological data, chemical data, NBC (nuclear, biological, chemical) nuclear detection alerts, and so on.

The mapping component 108 can include situation awareness software, GPS location technology, radio communications capability, text messaging capability, and orders/commands processing and communications capability. The tactical component 110 includes a computerized tactical scenarios subsystem 910 and a human tactical scenarios subsystem 912, some of the capabilities of which have been described supra. The computerized (or automatic) subsystem 910 picks from hundreds of pre-planned tactical action plans based on the ID and type of alert. Mission-specific scenarios can be executed from specific alert notice data such as location, calling a unit near there, or bringing in a dog and handler versus three squads for multiple alerts in a given area, for example, and other related action plans. The human subsystem 912 follows rules of engagement and mission-specific instructions. For example, “if you see something, call me”, or “if you see something, enter 1234 into the system for action instructions and notices”, or trigger is by location, etc.

The security systems component 112 facilitates the notification of and communication with public safety personnel and entities (e.g., medical, fire, police, and military) on a local, regional, statewide and even national basis.

The external interface component 114 includes a linking relationships software subsystem 914 that facilitates linking up to other databases and/or websites 916 that support the system 900. For example, COPLINK is a website that provides services related to criminal entities and related data. The external interface component 114 also includes a communications subsystem 918 that facilitates wired and/or wireless communications to, for example, an IP network and/or a cellular network. The subsystem accommodates many types of data and signals, including, but to limited to, voice, video and data.

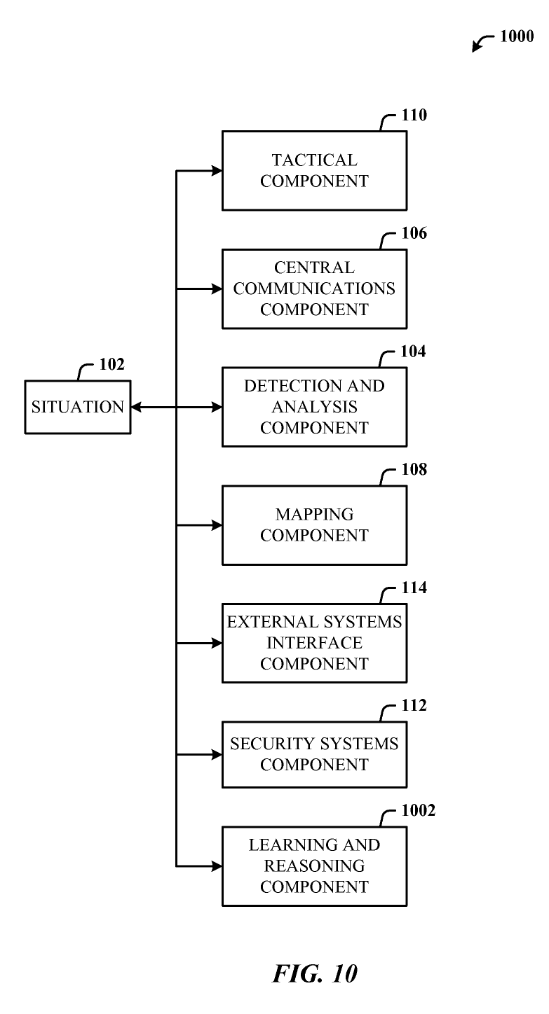

FIG. 10 illustrates a diagram of a command and control system 1000 that employs artificial intelligence (AI) in the form of machine learning and reasoning component 1002 which facilitates automating one or more features in accordance with the subject innovation. The subject architecture (e.g., in connection with selection) can employ various AI-based schemes for carrying out various aspects thereof. For example, a process for determining what services to dispatch and what routes should be taken by those services can be facilitated via an automatic classifier system and process.

Such classification can employ a probabilistic and/or other statistical analysis (e.g., one factoring into the analysis utilities and costs to maximize the expected value to one or more people) to prognose or infer an action that a user desires to be automatically performed.

Directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of ranking or priority.

As will be readily appreciated from the subject specification, the subject invention can employ classifiers that are explicitly trained (e.g., via a generic training data) as well as implicitly trained (e.g., via observing user behavior, receiving extrinsic information). For example, support vector machines are configured via a learning or training phase within a classifier constructor and feature selection module. Thus, the classifier(s) can be employed to automatically learn and perform a number of functions according to predetermined criteria.

In one example, the component 1002 can monitor central communications provided by the central communications component 106 related to which users are allowed access to channels of information and voice communications, for example. In another example, the component 1002 learns and reasons about routes of travel, weather conditions typical to the locale, traffic conditions, and patterns of people vehicle movement.

In yet another example, the component 1002 monitors sensors and sensor systems related which sensors are more provide more reliable information in a given situation, and based on other condition such as weather and availability of services. These are only but a few examples of the many uses for learning and reasoning about data, signals, events, conditions, systems, personnel, location, and so on.

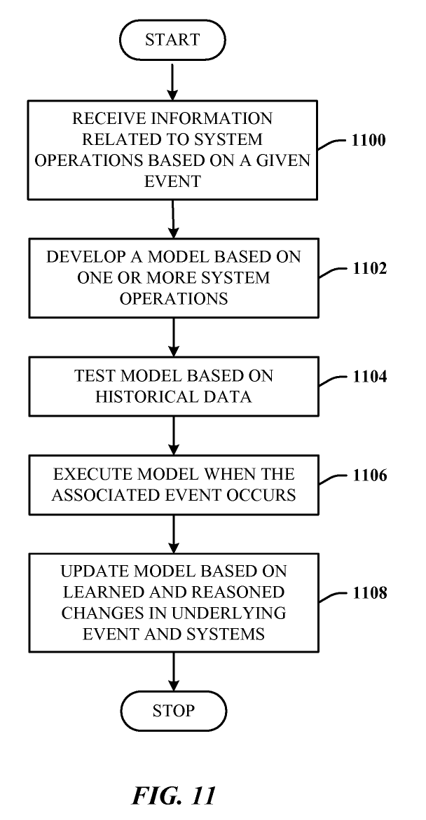

FIG. 11 illustrates a flow diagram of a methodology of developing a model based on event and system information in accordance with an aspect. At 1100, information is received related to system operations based on a given event. At 1102, a model is developed based on one or more system operations and system data. At 1104, the model is tested for a predetermined level of accuracy. At 1106, once accepted, the model is executed when a similar event occurs. At 1108, the model is updated based on learned and reasoned changes in the underlying event and/or systems.

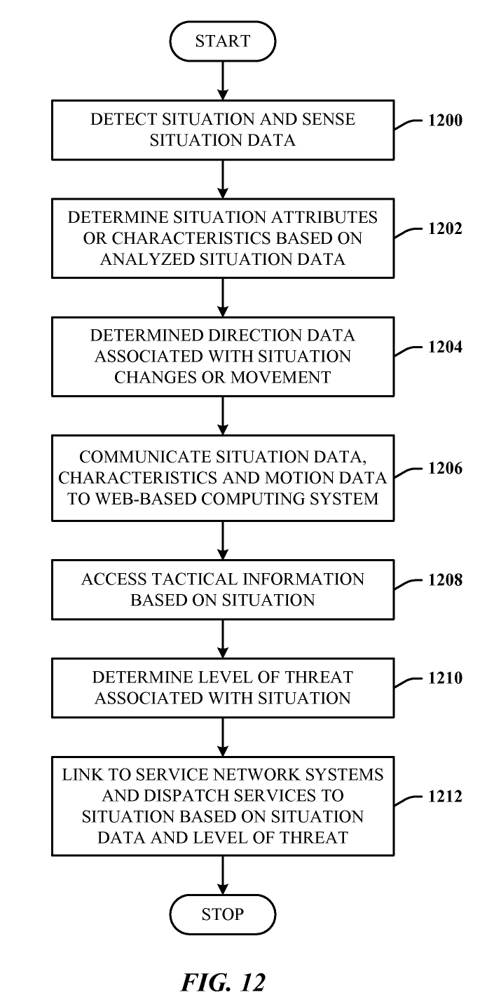

FIG. 12 illustrates a flow diagram of a methodology of processing situation movement and characteristics for command and control processing according to an aspect. At 1200, situation of interest is detected and situation data sensed. At 1202, situation characteristics are computed based on the analyzed data. At 1204, directional data associated with the situation is computed. This can include receiving GPS signals related to the situation location and movement. At 1206, the situation data, situation characteristics and motion data are communicated to a web-based communications system. At 1208, tactical information is accessed based on the situation and characteristics. At 1210, the level of threat is computed based at least on the situation and characteristics information. At 1212, communications are linked to other network systems related to services, and the services are dispatched to the situation area based in part on the situation data and level of threat information.

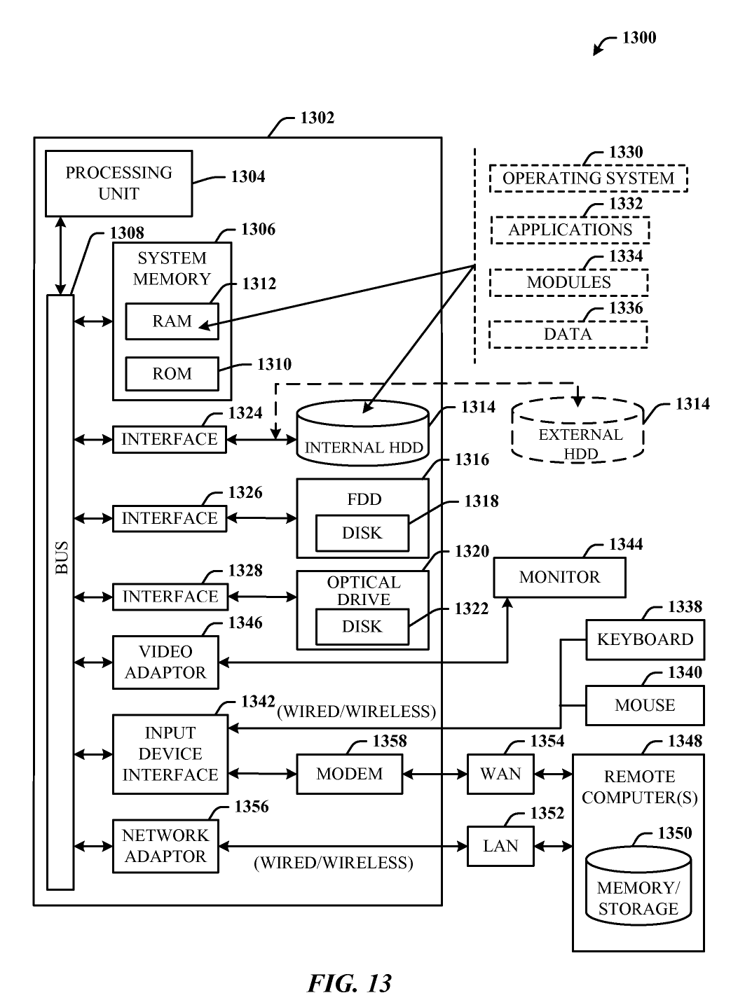

Referring now to FIG. 13, there is illustrated a block diagram of a computer operable to facilitate execution of one or more components of the disclosed command and control architecture. In order to provide additional context for various aspects thereof, FIG. 13 and the following discussion are intended to provide a brief, general description of a suitable computing environment 1300 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 13, the exemplary environment 1300 for implementing various aspects includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures may also be employed as the processing unit 1304.

The system bus 1308 can be any of several types of bus structure that may further interconnect to a memory bus (with or without a memory controller), a peripheral bus, and a local bus using any of a variety of commercially available bus architectures. The system memory 1306 includes read-only memory (ROM) 1310 and random access memory (RAM) 1312. A basic input/output system (BIOS) is stored in a non-volatile memory 1310 such as ROM, EPROM, EEPROM, which BIOS contains the basic routines that help to transfer information between elements within the computer 1302, such as during start-up. The RAM 1312 can also include a high-speed RAM such as static RAM for caching data.

The computer 1302 further includes an internal hard disk drive (HDD) 1314 (e.g., EIDE, SATA), which internal hard disk drive 1314 may also be configured for external use in a suitable chassis (not shown), a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as the DVD). The hard disk drive 1314, magnetic disk drive 1316 and optical disk drive 1320 can be connected to the system bus 1308 by a hard disk drive interface 1324, a magnetic disk drive interface 1326 and an optical drive interface 1328, respectively. The interface 1324 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1302, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. It is to be appreciated that the innovation can be implemented with various commercially available operating systems or combinations of operating systems.

A user can enter commands and information into the computer 1302 through one or more wired/wireless input devices, e.g., a keyboard 1338 and a pointing device, such as a mouse 1340. Other input devices (not shown) may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces, such as a parallel port, an IEEE 1394 serial port, a game port, a USB port, an IR interface, etc.

A monitor 1344 or other type of display device is also connected to the system bus 1308 via an interface, such as a video adapter 1346. In addition to the monitor 1344, a computer typically includes other peripheral output devices (not shown), such as speakers, printers, etc.

The computer 1302 may operate in a networked environment using logical connections via wired and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wired/wireless connectivity to a local area network (LAN) 1352 and/or larger networks, e.g., a wide area network (WAN) 1354. Such LAN and WAN networking environments are commonplace in offices and companies, and facilitate enterprise-wide computer networks, such as intranets, all of which may connect to a global communications network, e.g., the Internet.

When used in a LAN networking environment, the computer 1302 is connected to the local network 1352 through a wired and/or wireless communication network interface or adapter 1356. The adaptor 1356 may facilitate wired or wireless communication to the LAN 1352, which may also include a wireless access point disposed thereon for communicating with the wireless adaptor 1356.

When used in a WAN networking environment, the computer 1302 can include a modem 1358, or is connected to a communications server on the WAN 1354, or has other means for establishing communications over the WAN 1354, such as by way of the Internet. The modem 1358, which can be internal or external and a wired or wireless device, is connected to the system bus 1308 via the serial port interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.1 a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11 g applies to wireless LANs and provides 20+Mbps in the 2.4 GHz band. Products can contain more than one band (e.g., dual band), so the networks can provide real-world performance similar to the basic 10BaseT wired Ethernet networks used in many offices.

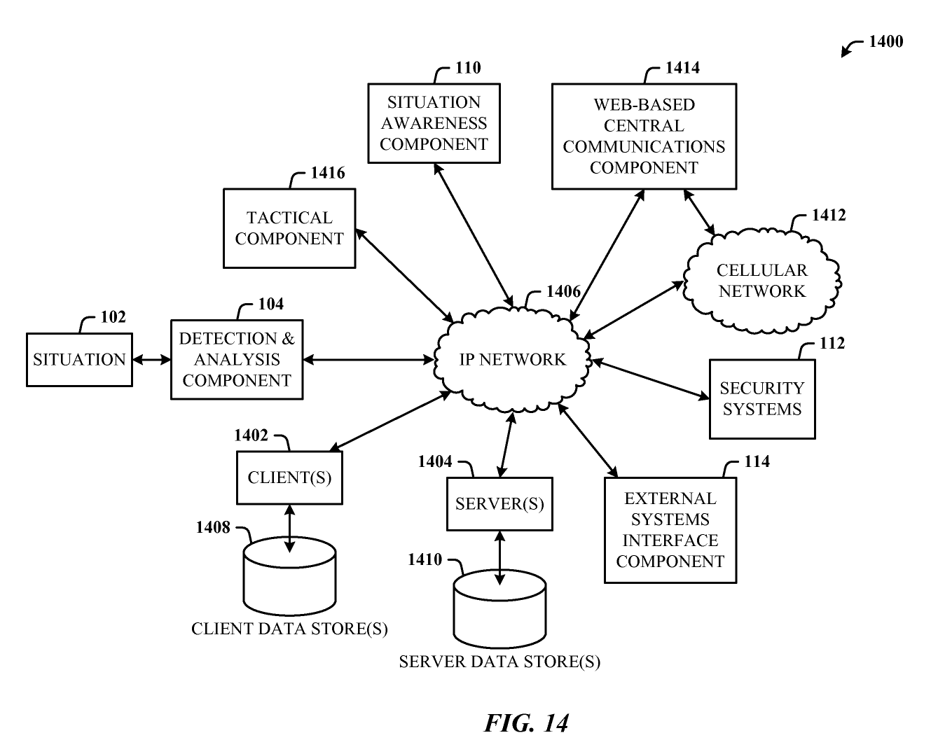

Referring now to FIG. 14, there is illustrated a schematic block diagram of an exemplary computing environment 1400 in accordance with another aspect. The system 1400 includes one or more client(s) 1402. The client(s) 1402 can be hardware and/or software (e.g., threads, processes, computing devices). The client(s) 1402 can house cookie(s) and/or associated contextual information by employing the subject innovation, for example.

The system 1400 also includes one or more server(s) 1404. The server(s) 1404 can also be hardware and/or software (e.g., threads, processes, computing devices). The servers 1404 can house threads to perform transformations by employing the invention, for example. One possible communication between a client 1402 and a server 1404 can be in the form of a data packet adapted to be transmitted between two or more computer processes. The data packet may include a cookie and/or associated contextual information, for example. The system 1400 includes a communication framework 1406 (e.g., a global communication network such as the Internet) that can be employed to facilitate communications between the client(s) 1402 and the server(s) 1404.

Communications can be facilitated via a wired (including optical fiber) and/or wireless technology. The client(s) 1402 are operatively connected to one or more client data store(s) 1408 that can be employed to store information local to the client(s) 1402 (e.g., cookie(s) and/or associated contextual information). Similarly, the server(s) 1404 are operatively connected to one or more server data store(s) 1410 that can be employed to store information local to the servers 1404.

The system 1400 can also include capabilities for communicating with a cellular network 1412 such that related system can be utilized to communicate data and signals for command and control purposes described herein. For example, the situation (or event) 102 can be sensed via the detection and analysis component 104, which communicates information across the network 1406 to a web-based central communications component 1414. The tactical component 110, security systems 112, and external systems interface component 114 are disposed on the IP network 1406 for access and data exchange, for example. A situational awareness component 1416, also disposed on the IP network 1406, facilitates generating situation reports for processing to select and access tactical components, for example. Any or all of the components of FIG. 14 have been described hereinabove, the capabilities and functions of which facilitate command and control on a local basis, regional basis and national basis when utilizing the disclosed architecture.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A command and control system, comprising:
a detection component that facilitates sensing of a situation and data analysis of detection data;
a central communications component that provides data management and communications management related to the detection data; and
a mapping component that processes the detection data and presents realtime location information related to a location of the situation.

2. The system of claim 1, wherein the detection component includes at least one of a sensor that senses data associated with the situation, an observer that observes the situation, and an asset associated with an area of the situation.

3. The system of claim 2, wherein the mapping component includes a geographic location technology that facilitates locating at least one of the sensor, the observer, and the asset.

4. The system of claim 2, wherein at least one of the sensor, observer, and asset receive and communicate situation attributes that are analyzed.

5. The system of claim 4, wherein the asset attributes are representative of a location of at least one of a fire vehicle, a medical vehicle, and a law enforcement vehicle.

6. The system of claim 4, wherein the sensor attributes are representative of a at least one of chemical data, explosives data, drug data, motion data, biological data, weapons data, acoustical data, nuclear data, audio data, and video data.

7. The system of claim 4, wherein the human attributes are representative of at least one of voice data, visual data, tactile data, motion data, and audio data.

8. The system of claim 1, further comprising a tactical component that processes tactical data for at least one of the mapping component, the central communications component, and the detection component.

9. The system of claim 1, further comprising a security system that initiates a security action based on the detection data.

10. The system of claim 9, wherein the security action includes requesting at least one of fire services, medical services, and law enforcement services.

11. The system of claim 1, wherein the central communications component facilitates communications over at least one of a cellular network and an IP network.

12. The system of claim 1, wherein the central communications component facilitates at least one of information rights management, voice/video and data collaboration, file management, workflow management, searching and indexing, and voice/text alerting.

13. The system of claim 12, wherein the voice/text alerting includes an alert related to detection by the detection component of at least one of nuclear data, chemical data, biological data, and radiological data.

14. The system of claim 1, further comprising an external interface component that facilitates communications to a law enforcement database.

15. The system of claim 1, wherein the detection component facilitates at least one of explosives analysis and drug analysis.

16. A method of facilitating a command and control architecture, comprising:
sensing event characteristics associated with an event;
analyzing the event characteristics for event data;
automatically determining location information of the event based on a geolocation technology;
transmitting the event data and the location information to a web-based central communications component;
mapping a route to the event based on the location information; and
dispatching appropriate services to the situation along the route based on the event data and the location information.

17. The method of claim 16, further comprising an act of accessing tactical information related to the event.

18. The method of claim 16, further comprising an act of messaging information to personnel dispatched to the event.

19. The method of claim 16, further comprising an act of generating a session via the web-based communications component that facilitates group communications to selected personnel involved with addressing the event.

20. A command and control system, comprising:
means for sensing and analyzing situation data associated with a situation;
means for automatically determining location information of the situation based on a geolocation technology;
means for transmitting at least one of the situation data and the location information to a web-based central communications component;
means for accessing tactical information for related to the situation;
means for accessing environmental data related to conditions associated with the situation; and
means for dispatching security and emergency services to the situation along automatically mapped routes based on the situation data and the location information.
